(19) United States
(12) Patent Application Publication
(10) Pub. No.: US 2026/0261434 A1
(43) Pub. Date: Sep. 3, 2026

(54) Concept for a User-Specific-Provision and Charging Contract Certificates

(71) Applicant: Bayerische Motoren Werke Aktiengesellschaft, Muenchen (DE)

(72) Inventors: Florian Kotsch, Muenchen (DE); Harald Hofmeier, Eching (DE); Holger Wierschin, Markt Indersdorf (DE)

(21) Appl. No.: 19/164,968

(22) PCT Filed: Jan. 31, 2024
(86) PCT No.: PCT/EP2024/052380

§ 371 Date: Sep. 12, 2025

(30) Foreign Application Priority Data
Mar. 20, 2023 (DE) 10 2023 106 848.2

(51) Int. Cl. H04L 9/32

(52) U.S. Cl. CPC H04L 9/3263

(57) ABSTRACT

A charging controller for a vehicle includes a control circuit and at least one interface for communication with a charging infrastructure. The control circuit is configured to receive a cryptographically secured provisioning certificate, wherein the cryptographically secured provisioning certificate comprises a unique identifier, wherein the unique identifier is linked to a user account of a driver of the vehicle, and receive one or more cryptographically secured charging contracts, wherein the one or more cryptographically secured charging contracts are based on the cryptographically secured provisioning certificate. The control circuit is further configured to store the provisioning certificate and at least one charging contract of the one or more cryptographically secured charging contracts in a cryptographically secured element, and authenticate the charging controller with respect to the charging infrastructure based on the at least one charging contract stored in the cryptographically secured element.

### CROSS-REFERENCE TO RELATED APPLICATIONS

The present application is the U.S. national phase of PCT Application PCT/EP 2024/052380 filed on Jan. 31, 2024, which claims priority of German patent application No. 10 2023 106 848.2 filed on Mar. 20, 2023, the entire contents of which are incorporated by reference herein.

### FIELD

The present disclosure relates to vehicles and particularly to a charging controller for a vehicle.

### BACKGROUND

Plug & Charge (a charging standard for charging electric vehicles) is based on the ISO 15118 industry standard. Using Plug & Charge (referred to below as P&C), drivers of electric vehicles, such as battery electric vehicles (BEV) or hybrid vehicles (also referred to as PHEV, Plug-in Hybrid Electric Vehicle, a motor vehicle having a hybrid drive, of which the battery can be charged by the engine and by plugging in a charging plug) can be authenticated at public charging points only by plugging in the charging cable and thereby charging the vehicle battery. The authentication takes place with a digital contract certificate in accordance with the standard. The contract certificate contains, inter alia, the contract number. The charging point operator (CPO) can bill for the charging procedure with this number via the existing roaming platforms with the contract provider (EMP or MO, Electro Mobility Provider or Mobility Operator, often the same as the EMP), or can bill the customer directly (if the CPO is at the same time the contract provider). The mode of operation will be described in detail below.

According to the current status of the standard (ISO 15118-2), the vehicle can transmit only one certificate to the charging point; in many systems, only one certificate is therefore held on the vehicle. The certificate is normally stored on the charging device in accordance with the standard. Certificates can either be installed via PLC (Power Line Communication) from the charging point, or via a backend (i.e. via a server)/telematics connection. Contract certificates are managed in a shared pool in the backends/servers. The certificates are created by the MO, and are retrieved by the OEM (Original Equipment Manufacturer), e.g. through the vehicle manufacturer. In accordance with ISO 15118-2, the contract certificates are linked to a vehicle, and not to a vehicle user. A basic prerequisite for the installation of a contract certificate is the provisioning certificate, which is similarly issued specifically for the vehicle for this purpose and is a one-off certificate. For provisioning certificates and contract certificates (i.e. the certificates of the charging contracts), along with the certificate chain (through to the root certificate), the associated private/secret key is also always stored in the secure memory of the vehicle. The secure memory for the private keys is frequently a specific HSM (Hardware Security Module) which has a restricted memory.

In modern vehicles, it is possible for vehicle users to log in to the vehicle with personal user accounts and further contact points (e.g. a mobile application). Each vehicle can have a designated main user and possibly a plurality of secondary users.

The need exists for an improved system and method for the technical security of the charging procedure for electric vehicles.

### SUMMARY

The present disclosure relates to the linking of contract certificates and provisioning certificates to a vehicle that is not mandatory for guaranteeing the security of the charging authentication. The aforementioned standard merely prescribes that each provisioning certificate has a unique identifier, referred to as the PCID (Provisioning Certificate Identifier). This identifier can match the chassis number or VIN (Vehicle Identification Number), whereby the identifier is linked to the vehicle, or can be individually chosen (restricted in format by the standard), as long as it is ensured that the identifier is unique and distinct. In the present disclosure, provisioning certificates are used which are linked to a user account of a driver (or, more generally, a “user”) of the vehicle rather than to the vehicle. A provisioning certificate of this type is then incorporated, for example when the user logs in to the vehicle, together with the at least one charging contract based on the provisioning certificate, into a cryptographically secured element of a charging controller of the vehicle and is stored, and is subsequently used for the authentication of the charging controller with respect to a charging infrastructure. As a result, the driver (or user) of the vehicle can use “his” charging contracts in different vehicles without this functionality having to be explicitly supported by the aforementioned ISO standard.

One aspect of the present disclosure relates to a charging controller for a vehicle. The charging controller comprises at least one interface for communication with a charging infrastructure. The charging controller comprises a cryptographically secured element. The charging controller comprises a control circuit. The control circuit is designed to receive a cryptographically secured provisioning certificate. The cryptographically secured provisioning certificate comprises a unique identifier. The unique identifier is linked to a user account of a driver of the vehicle. The control circuit is designed to receive one or more cryptographically secured charging contracts. The one or more cryptographically secured charging contracts are based on the cryptographically secured provisioning certificate. The control circuit is designed to store the provisioning certificate and at least one charging contract of the one or more cryptographically secured charging contracts in the cryptographically secured element. The control circuit is designed to authenticate the charging controller with respect to the charging infrastructure on the basis of the at least one charging contract stored in the cryptographically secured element. As a result, the driver (or user) of the vehicle can use “his” charging contracts in different vehicles without this functionality having to be explicitly supported by the aforementioned ISO standard.

In particular, the unique identifier cannot be linked to the vehicle. This simplifies the use of the provisioning certificate in a plurality of vehicles.

The control circuit can further be designed, for example, to receive at least one second cryptographically secured provisioning certificate which comprises a second unique identifier that is linked to a user account of a second driver, and one or more second cryptographically secured charging contracts based on the second provisioning certificate. The control circuit can be designed to store the second provisioning certificate and at least one second charging contract of the one or more second charging contracts in the cryptographically secured element and to authenticate the charging controller with respect to the charging infrastructure on the basis of the at least one second charging contract. A changeover between charging contracts of different drivers is thus possible within the vehicle, e.g. in a car-sharing scenario, in a company fleet scenario, or in the case of a private and business use of a company vehicle. The concept is not restricted to two provisioning certificates-the number of provisioning certificates is possibly limited only by the number of users assigned to the vehicle.

If a plurality of provisioning certificates are used, this provides a plurality of options depending on how many provisioning certificates are storable in the cryptographically secured element, in a memory of the charging controller outside the cryptographically secured element, or in a memory outside the charging controller. The control circuit can be designed, for example, to store the second provisioning certificate and the at least one second charging contract in addition to the provisioning certificate and the at least one charging contract in the cryptographically secured element. In addition, the control circuit can be designed to store a selection indicating the charging contract that is to be used for the authentication. This enables a use of the charging contracts by a plurality of users without the need to remove and add the respective certificates in the event of a changeover of driver/user.

Alternatively (or additionally, depending on the memory capacity of the cryptographically secured element), the control circuit can be designed to remove the provisioning certificate and the at least one charging contract in encrypted form from the cryptographically secured element, and to store the second provisioning certificate and the at least one second charging contract in the cryptographically secured element following the removal. Due to the encrypted removal, any necessary memory space can be created in the cryptographically secured element for storing the second provisioning certificate and for storing the at least one second charging contract. Due to the removal in encrypted form, the removal can be carried out without compromising the security of the certificates.

The removal can be effected to a memory of the charging controller, or to a memory outside the charging controller. In other words, the control circuit can be designed to store the provisioning certificate and the at least one charging contract in encrypted form on a further memory of the charging controller, wherein the further memory is arranged outside the cryptographically secured element. Alternatively (or additionally), the control circuit can be designed to store the provisioning certificate and the at least one charging contract in encrypted form on a further memory outside the charging controller. Storage in a memory of the charging controller enables a more simple implementation without involving further devices, but is dependent on the available memory. Storage in a memory outside the charging controller increases the implementation complexity, but enables the use of a memory shared by a plurality of controllers in the vehicle.

In order to guarantee the security of the removed data, the encryption of the data can be linked to the charging controller and, in particular, to the cryptographically secured element. The provisioning certificate and the at least one charging contract can be encrypted, for example, by means of a cryptographic key which is stored within the cryptographically secured element. This improves the security of the encryption, since the encrypted data remain secure even if the memory is uninstalled.

Corresponding to the removal of the data in encrypted form from the cryptographically secured element, the data can also be loaded in encrypted form and can be decrypted and stored in the cryptographically secured element. In other words, the control circuit can be designed to receive at least the second provisioning certificate and the one or more second charging contracts in encrypted form from a memory inside or outside the charging controller. As a result, the respective data can be reloaded into the cryptographically secured element following a previous encrypted removal. As already mentioned above, this is essentially possible for any number of provisioning certificates and associated charging contracts.

In order to signal to the charging controller that a different provisioning certificate is to be used in future with a corresponding charging contract, the current driver can log in to the vehicle via a user interface. This login can then be signaled to the charging controller, whereupon the corresponding provisioning certificate and a corresponding charging contract can be stored in the cryptographically secured element. Correspondingly, the control circuit can be designed to perform the reception and storage of the second provisioning certificate and the one or more second charging contracts in response to a control signal from a user interface controller of the vehicle.

A further aspect of the present disclosure relates to a corresponding method for a charging controller for a vehicle. The method comprises receiving a cryptographically secured provisioning certificate, wherein the cryptographically secured provisioning certificate comprises a unique identifier, wherein the unique identifier is linked to a user account of a driver of the vehicle. The method comprises receiving one or more cryptographically secured charging contracts, wherein the one or more cryptographically secured charging contracts are based on the cryptographically secured provisioning certificate. The method comprises storing the provisioning certificate and at least one charging contract of the one or more cryptographically secured charging contracts in a cryptographically secured element of the charging controller. The method comprises authenticating the charging controller with respect to a charging infrastructure based on the at least one charging contract stored in the cryptographically secured element. The method can be carried out, for example, by the controller.

A further aspect of the present disclosure relates to a corresponding program having a program code to carry out the method for the charging controller when the program code is executed on a computer, a processor, a control module, a control circuit or a programmable hardware component of the charging controller.

A further aspect of the present disclosure relates to a user interface controller for a vehicle. The user interface controller comprises at least one interface for communication with a charging controller of the vehicle and for communication with a user interface. The user interface controller comprises a control circuit designed to receive a user input via the user interface. The user input indicates that a driver of the vehicle is logging in to the vehicle via his user account. The control circuit is designed to provide a control signal to the charging controller if a unique identifier, which is contained in a provisioning certificate on which a charging contract is based which is currently being used for the authentication with respect to a charging infrastructure, is linked to a different user account. The control signal indicates that a second provisioning certificate and at least one charging contract based on the second provisioning certificate are to be used for the authentication with respect to the charging infrastructure. It is thereby possible to signal to the charging controller that a different provisioning certificate is to be used in future with a corresponding charging contract, e.g. in the event of a change of driver.

The control circuit can be designed, for example, to output a representation of one or more charging contracts via the user interface, said charging contracts being based on the provisioning certificate of which the unique identifier is linked to the currently logged in user account. This enables the newly logged in driver to select one charging contract if a plurality of charging contracts are linked to the same provisioning certificate.

A further aspect of the present disclosure relates to a corresponding method for a user interface controller for a vehicle. The method comprises receiving a user input via a user interface. The user input indicates that a driver of the vehicle is logging in to the vehicle via his user account. The method comprises providing a control signal to a charging controller of the vehicle if a unique identifier, which is contained in a provisioning certificate on which a charging contract is based which is currently being used for the authentication with respect to a charging infrastructure, is linked to a different user account. The control signal indicates that a second provisioning certificate and at least one charging contract based on the second provisioning certificate are to be used for the authentication with respect to the charging infrastructure. The method can be carried out, for example, by the user interface controller.

A further aspect of the present disclosure relates to a corresponding program having a program code to carry out the method for the user interface controller when the program code is executed on a computer, a processor, a control module or a programmable hardware component, e.g. the user interface controller.

### BRIEF DESCRIPTION OF THE DRAWINGS

Exemplary embodiments are explained in detail below with reference to the attached figures, in which:

FIG. 1a shows a schematic diagram of a charging controller;

FIG. 1b shows a flow diagram of a method for a charging controller;

FIG. 2a shows a schematic diagram of a user interface controller;

FIG. 2b shows a flow diagram of a method for a user interface controller;

FIG. 3 shows a schematic diagram of Plug & Charge from a technical perspective; and

FIG. 4 shows a simplified representation of the technical infrastructure for the use of Plug & Charge.

### DESCRIPTION

Exemplary embodiments will now be described in more detail with reference to the attached figures. However, further possible examples are not restricted to the features of these detailed described embodiments. These embodiments can have modifications of the features, as well as equivalents and alternatives to the features. Furthermore, the terminology that is used herein to describe specific examples is not intended to be restrictive for further possible examples.

In the entire description of the figures, identical or similar reference signs relate to identical or similar elements or features which can be implemented in each case identically or in modified form while providing an identical or similar function. The thickness of lines, layers and/or areas can be exaggerated in the figures for illustrative purposes.

If two elements A and B are combined using an “or”, this is to be understood to mean that all possible combinations are disclosed, i.e. A only, B only, as well as A and B, unless expressly defined otherwise in individual cases. The phrase “at least one of A and B” or “A and/or B” can be used as an alternative wording for the same combinations. The same applies to combinations of more than two elements.

If a singular form, e.g. “a, an, one”, and “the”, is used, and the use of £ only a single element is neither explicitly nor implicitly defined as mandatory, further examples can also use 10 plurality of elements to implement the same function. If a function is described below as being implemented using a plurality of elements, further examples can implement the same function using a single element or a single processing entity. It is furthermore obvious that the terms “comprises”, “comprising”, “has” and/or “having” are used to describe the presence of the indicated features, integers, steps, operations, processes, elements, components and/or a group thereof, but do not exclude the presence of the addition of one or more other features, integers, steps, operations, processes, elements, components and/or a group thereof.

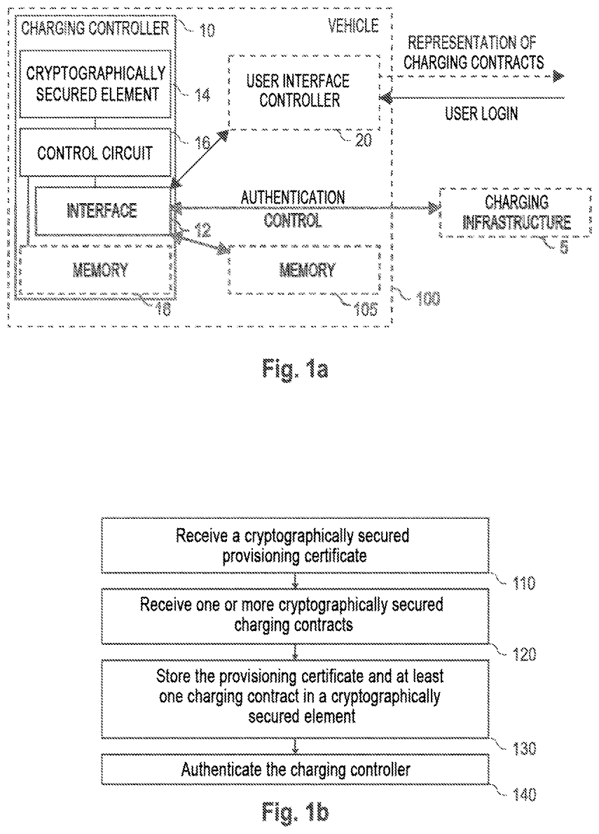

FIG. 1a shows a schematic diagram of a charging controller 10 for a vehicle 100, wherein the charging controller 10 is part of the vehicle 100. The charging controller comprises at least one interface 12 for communication with a charging infrastructure 5 (e.g. a charging point), e.g. using power line communication. In some examples, the at least one interface 12 comprises an interface for communication with a user interface controller 20 of the vehicle 100, at least one interface for communication with a server (not shown), e.g. via a telematics connection/mobile radiocommunication connection, and/or an interface for communication with a memory 105 of the vehicle. The charging controller 10 comprises a cryptographically secured element 14, e.g. a “Secure Element” or “Trusted Execution Environment”. The charging controller 10 comprises a control circuit 16 which is coupled to the cryptographically secured element 14 and the at least one interface 12. The cryptographically secured element can, for example, be a part of the control circuit 16 or a separate component. The charging controller 10 further optionally comprises a memory 18 which is coupled to the control circuit 16.

The control circuit 16 is designed to receive a cryptographically secured provisioning certificate. The cryptographically secured provisioning certificate comprises a unique identifier. The unique identifier is linked to a user account of a driver of the vehicle. In connection with the present disclosure, a driver of the vehicle is not necessarily the person controlling the vehicle. If the vehicle is an autonomous vehicle, the driver is the person using the vehicle for travelling purposes and/or the person specifying the destination of the autonomous vehicle. The control circuit 16 is designed to receive one or more cryptographically secured charging contracts. The one or more cryptographically secured charging contracts are based on the cryptographically secured provisioning certificate. The control circuit 16 is designed to store the provisioning certificate and at least one charging contract of the one or more cryptographically secured charging contracts in the cryptographically secured element. The control circuit 16 is designed to authenticate the charging controller with respect to the charging infrastructure based on the at least one charging contract stored in the cryptographically secured element.

FIG. 1b shows a flow diagram of a corresponding method for the charging controller 10. The method comprises receiving 110 the cryptographically secured provisioning circuit. The method comprises receiving 120 the one or more cryptographically secured charging contracts. The method comprises storing 130 the provisioning certificate and the at least one charging contract of the one or more cryptographically secured charging contracts in the cryptographically secured element 14 of the charging controller. The method comprises authenticating 140 the charging controller 10 with respect to the charging infrastructure 5 based on the at least one charging contract stored in the cryptographically secured element. The charging controller, the corresponding method and a corresponding computer program are described below with reference to the charging controller. Features that can be described in connection with the charging controller can similarly be applied to the corresponding method or computer program.

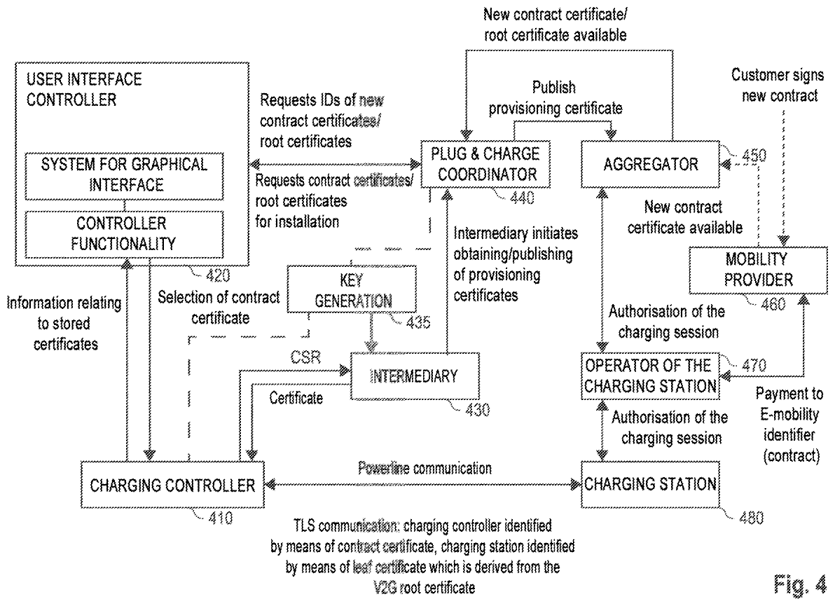

In the charging communication in accordance with the Plug & Charge standard, provisioning certificates are used to prevent misuse of 44 charging contracts (also known as contract certificates). The provisioning certificate comprises a public part (i.e. a public key). The private part of the provisioning certificate, when used, is held in the cryptographically secured element 14, and a public part of the provisioning certificate, as shown in FIG. 4, is provided to the remaining participants, e.g. via one or more aggregators. The public part can then be used to encrypt the cryptographically secured charging contracts or restrict their use, so that they can be used only when the private part of the provisioning certificate is used, wherein the commissioning takes place within the cryptographically secured element. Along with the private key of the provisioning certificates and one or more private keys of contract certificates/charging contracts, the certificate chain (through to the root certificate) can also be stored in each case in the cryptographically secured element. However, this is mostly omitted in order to save memory space.

According to at least some embodiments disclosed herein, if a provisioning certificate is tied to one vehicle, a user can conclude a personal charging contract (e.g. via a third-party traction power provider), but, in the event of a change of vehicle, a new certificate (of the charging contract) will be issued by the traction power provider, since this vehicle has a different provisioning certificate/PCID. Cost is incurred by the customer and by the contract provider. Each issue of a certificate further incurs costs for the traction power provider, wherein the customer must directly or indirectly pay these costs. The restriction of the provisioning certificate/PCID to the allocation to precisely one vehicle furthermore does not ensure, for example, that secondary users can use a contract exclusively for themselves, or that a contract is always available to all users of the vehicle. This restriction similarly does not ensure that a temporary user can transfer his personal Plug & Charge contract, e.g. to a rental vehicle.

In the present disclosure, instead of a 1:1 relationship between the vehicle and the PCID/provisioning certificate, the provisioning certificate of the PCID is issued once for each user account identifier (of the personal user account). Since the standard does not prescribe mandatory use of the chassis number, this identifier can be freely chosen insofar as it is unique to each user account.

The cryptographically secured provisioning certificate therefore comprises a unique identifier which is linked to a user account of a driver of the vehicle, e.g. the aforementioned user account identifier. The identifier is unique, i.e. it is uniquely linked to one user account, so that no second user account (or no vehicle) can use the same identifier. The identifier can comprise, for example, a prefix which is used exclusively by a vehicle manufacturer, and a further component which is unique among the user accounts of the vehicle manufacturer. In particular, however, the identifier can be independent from an identifier, such as a chassis number, of the vehicle. The unique identifier can consequently not be linked to one vehicle.

The charging controller receives such a provisioning certificate with the unique identifier which is linked to the user account of the driver of the vehicle. This provisioning certificate can be incorporated into the charging controller and, in particular, into the cryptographically secured element, for example before the delivery of the vehicle, insofar as the user account of the purchaser or lessee of the vehicle is known. Alternatively, the provisioning certificate can be incorporated into the charging controller, and, in particular, into the cryptographically secured element when the driver first logs in to the vehicle (e.g. via a user interface of the vehicle or via a mobile application). For this purpose, the provisioning certificate can be downloaded, for example, from a server of the vehicle manufacturer (see, for example, FIG. 4, where the certificate is downloaded by the intermediary 430), or can be generated in the cryptographically secured element and transmitted in encrypted form to the server. The key pair of the provisioning certificate can be generated, for example, on the charging controller (within the cryptographically secured element), and the certificates can be created via a certificate signing request (CSR), e.g. by the intermediary 430 shown in FIG. 4. Although the key pair can be created by the charging controller, the key pair can also be created elsewhere, e.g. by a cryptographically secured server. This is particularly advantageous if the provisioning certificate is tied to a user account rather than to a vehicle. The provisioning certificate can then be incorporated into the charging controller during a login with the user account on a vehicle.

In addition to the provisioning certificate, the one or more charging contracts which are based on the cryptographically secured provisioning certificate are obtained (i.e. received or read out from a memory of the vehicle). These charging contracts (or rather cryptographically secured certificates of the respective charging contracts, i.e. the contracts with a mobility operator Or charging infrastructure operator) are similarly stored in the cryptographically secured element if they are intended to be used for authentication. One charging contract or a plurality of charging contracts can be stored in the cryptographically secured element depending on the available memory space. In the latter case, in addition to the charging contracts, information indicating which charging contract (or certificate) is intended to be used for authentication can also be stored (inside or outside the cryptographically secured element). During the authentication of the charging controller, at least the certificate of the charging contract is then used to cryptographically secure the communication with the charging infrastructure 5 identify the charging controller with respect to the charging infrastructure. The charging contracts and the communication with the charging infrastructure can be based on the ISO 15118-2 standard. However, the basic principle operates with both variants, i.e. ISO 15118-2 and ISO 15118-20.

The system and method disclosed herein is advantageously usable, in particular, in two scenarios-when a driver who has already concluded one or more charging contracts and logs in to a new vehicle, and when a vehicle is used by a plurality of drivers. In the latter case, in particular, a mechanism can then be provided which either holds provisioning certificates or the associated private keys in the secure memory of the cryptographically secured element for a (restricted) number of users, or, in the event of a change of user, installs the corresponding private key in the secure memory from an encrypted container of a non-secure memory. In addition, depending on the availability of secure memory in the vehicle, the private keys of the contract certificates can be collected for all users and permanently stored in the secure memory, or, similarly in the event of a change of user, can be installed in the vehicle from an encrypted container in order to map the installation status respectively defined for a user.

For this purpose, the control circuit can further be designed to receive, in addition to the (first) provisioning certificate, one or more further provisioning certificates also, and to store them in the cryptographically secured element. The description below focuses on a second provisioning certificate (along with a second contract based thereon or second contracts based thereon). However, more than two charging contracts are essentially possible. The number of provisioning certificates can depend, for example, on the number of users assigned to the vehicle. The control circuit can thus further be designed to receive at least one second cryptographically secured provisioning certificate which comprises a second unique identifier which is linked to a user account of a second driver, and one or more second cryptographically secured charging contracts based on the second provisioning certificate. These charging contracts can then be stored in the cryptographically secured element and can be used as an alternative to the first provisioning certificate and associated charging contract for the authentication. The control circuit can consequently further be designed to store the second provisioning certificate and at least one second charging contract of the one or more second charging contracts in the cryptographically secured element, and to identify the charging controller with respect to the charging infrastructure based on the at least one second charging contract.

A distinction is now made below between three cases. In the first case, a plurality of provisioning certificates (and associated charging contract(s)) are stored in the cryptographically secured element. The control circuit can be designed accordingly to store the second provisioning certificates and the at least one second charging contract in addition to the provisioning certificate and the at least one charging contract in the cryptographically secured element, and to store a selection indicating which charging contract is to be used for the authentication.

In the second case, an actively used provisioning certificate (and associated charging contract(s)) is stored in the cryptographically secured element, and at least one unused provisioning certificate (and associated charging contract(s)) is removed to a different (non-secure) memory 18 of the charging controller. In other words, the control circuit can be designed to remove the provisioning certificate and the at least one charging contract in encrypted form from the cryptographically secured element, and to store the second provisioning certificate and the at least one second charging contract in the cryptographically secured element following the removal. In the second case, this is done by storing the provisioning certificate and the at least one charging contract in encrypted form in the further memory 18 of the charging controller, wherein the further memory is arranged outside the cryptographically secured element.

In the third case, an actively used provisioning certificate (and associated charging contract(s) ) is stored in the cryptographically secured element, and at least one unused provisioning certificate (and associated charging contract(s) ) is removed in encrypted form to a different (non-secure) memory 105 of the vehicle. In the third case, this is done, similar to the second case, by storing the provisioning certificate and the at least one charging contract in encrypted form in a further memory 105 outside the charging controller. However, mixed cases involving the three above-mentioned cases are also possible, e.g. depending on the memory capacity of the cryptographically secured element or the memory 18 of the charging controller.

If the provisioning certificate and the at least one charging contract (or, later, the second provisioning certificate and at least one second charging contract) are removed, this is done in encrypted form. A cryptographic key which is then present within the cryptographically secured element (e.g. because the key was generated within the cryptographically secured element) can be used for this purpose. The provisioning certificate and the at least one charging contract can thus be encrypted by means of a cryptographic key which is stored within the cryptographically secured element. The respective provisioning certificate and the charging contract or charging contracts can be encrypted and stored together in a container.

Similar to the removal of the provisioning certificate and the at least one charging contract, the second (or third, fourth, etc.) provisioning certificate and associated charging contract(s)) can be added from a non-secure memory of the charging controller or outside the charging controller (but inside the vehicle). The control circuit can be designed, for example, to receive at least the second provisioning certificate and the one or more second charging contracts in encrypted form from a memory inside or outside the charging controller. They can then be decrypted by means of the key secured within the cryptographically secure element.

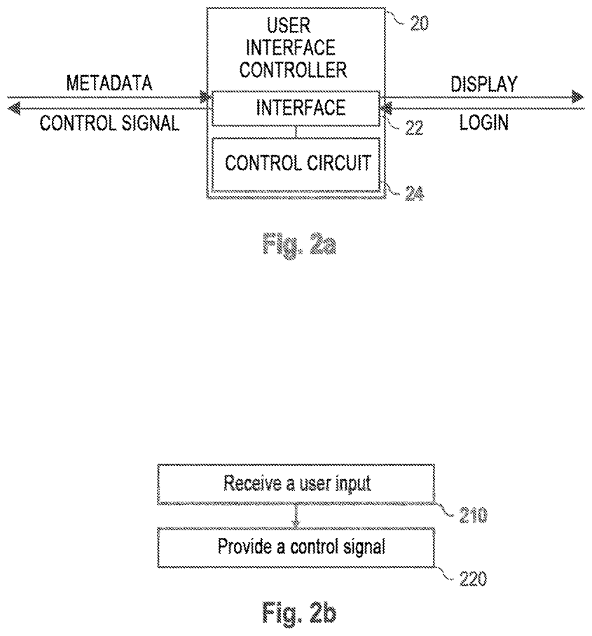

In order to control the procedure, the charging controller can be controlled by means of the user interface controller 20 of the vehicle. The control circuit can be designed, for example, to perform the reception and storage of the second provisioning certificate and the one or more second charging contracts (and/or the provisioning certificate and the one or more charging contracts, and/or a third/fourth provisioning certificate and corresponding charging contracts) in response to a control signal from a user interface controller 20 of the vehicle. This control signal can indicate, for example, that the second provisioning certificate and the one or more second charging contracts are to be received (e.g. through reception from a server, or through read-out, in encrypted form, from a memory of the vehicle or of the charging controller), and/or are to be used instead of the first provisioning certificate and the charging contract for authentication. This is explained below with reference to FIGS. 2a and 2b.

In the preceding description, it has been assumed that each driver uses the charging contract(s)) which is/are linked to his user account. Insofar as sufficient secure memory is available, the user can, however, also decide that his contract, notwithstanding the preceding point, is also usable for other drivers/users.

The at least one interface 12 can correspond, for example, to one or more inputs and/or one or more outputs for receiving and/or transmitting information, e.g. in digital bit values, based on a code, within a module, between modules, or between modules of different entities. In exemplary embodiments, the control circuit 16 can correspond to any controller or processor or to a programmable hardware component. The control circuit 16 can also be implemented, for example, as software that is programmed for a corresponding hardware component. In this respect, the control circuit 16 can be implemented as programmable hardware having correspondingly adapted software. Any processors, such as digital signal processors (DSPs), can be used. Exemplary embodiments are not restricted to a specific type of processor. Any processors or even a plurality of processors are conceivable for the implementation. In some examples, the control circuit 16 can comprise the cryptographically secured element 14.

The memory 18 of the charging controller and/or the memory 105 of the vehicle can comprise at least one element from the group comprising: computer-readable storage medium, magnetic storage medium, optical storage medium, hard disk, flash memory, diskette, random access memory, programmable read-only memory (PROM), erasable programmable read-only memory (EEPROM), electronically erasable programmable read-only memory (EEPROM), and network memory.

The vehicle 100 can correspond, for example, to a land vehicle, a watercraft, an aircraft, a rail vehicle, a road vehicle, an automobile, an off-road vehicle, a motor vehicle, or a truck.

More details and aspects of the charging controller, the corresponding method and the computer program will be mentioned in connection with the concept or examples described below (e.g. FIG. 2a to 4). The charging controller, the corresponding method and the computer program can comprise one or more additional optional features corresponding to one or more aspects of the proposed concept or the described examples, as set out above or below.

FIG. 2a shows a schematic diagram of a user interface controller 20 (also referred to as a head unit) for a vehicle. The user interface controller 20 comprises at least one interface 22 for communication with a charging controller 10 (shown in FIG. 1a) of the vehicle and for communication with a user interface, e.g. a touch-sensitive screen or a combination of a screen and a haptic input device, of the vehicle (not shown) or outside the vehicle (e.g. a user interface of a mobile device of a driver of the vehicle, via a mobile application). The user interface controller comprises a control circuit 24 which is coupled to the at least one interface 22. The control circuit 24 is designed to receive a user input via the user interface. The user input indicates that a driver of the vehicle is logging in to the vehicle via his user account. The control circuit 24 is designed to provide a control signal to the charging controller if a unique identifier, which is contained in a provisioning certificate on which a charging contract is based which is currently being used for the authentication with respect to a charging infrastructure, is linked to a different user account. The control signal indicates that a second provisioning certificate and at least one charging contract based on the second provisioning certificate are to be used for the authentication with respect to the charging infrastructure.

FIG. 2b shows a flow diagram of a corresponding method for the user interface controller 20. The method comprises receiving 210 the user input via the user interface. The method comprises providing 220 the control signal to the charging controller of the vehicle if the unique identifier, which is contained in the provisioning certificate on which the charging contract is based which is currently being used for the authentication with respect to a charging infrastructure, is linked to a different user account.

The user interface controller, the corresponding method and a corresponding computer program are described below with reference to the user interface controller. Features which can be described in connection with the user interface controller can similarly be applied to the corresponding method or computer program.

As already explained in connection with FIG. 1a and 1b, the trigger for storing (or activating) a provisioning certificate along with a charging contract or charging contracts in the cryptographically secured element is a login of the driver/user on the vehicle. However, this procedure is not intended to take place with each login of a user in the vehicle-if the correct provisioning certificate is already installed in the cryptographically secured element and the use of an associated charging contract is activated for authentication, it is not necessary to control the charging controller accordingly. The control signal is therefore provided only if the charging contract which is currently being used (or is intended to be used) for the authentication with respect to the charging infrastructure is based on a provisioning certificate which is not linked to the user account of the driver/user who is logging in. This done by comparing the unique identifier of the user account of the user logging in with the unique identifier which is used in the provisioning certificate on which the charging contract currently being used for authentication is based. In order to carry out this comparison, the charging controller can provide the user interface controller with metadata relating to the available or currently used provisioning certificates and charging contracts. If the unique identifiers are different, the control signal is provided to instruct the charging controller to store the second provisioning certificate and at least one associated charging contract in the cryptographically secured element. The second provisioning certificate comprises the unique identifier of the user account of the user who is logging in.

If the user/driver is logged in, a list of available charging contracts can be displayed to him. The control circuit can be designed, for example, to output a representation of one or more charging contracts via the user interface, said charging contracts being based on the provisioning certificate of which the unique identifier is linked to the currently logged in user account. This list can be based on the metadata which the charging controller has provided to the user interface controller. Depending on the possible storage scenario, a mechanism in the user administration can therefore ensure that a logged in user sees (only), in the user interface, or can use only the contract certificates which are assigned to the unique identifier (e. g. the PCID) of this user.

The at least one interface 22 can correspond, for example, to one or more inputs and/or one or more outputs for receiving and/or transmitting information, e.g. in digital bit values, based on a code, within a module, between modules or between modules of different entities.

In exemplary embodiments, the control circuit 24 can correspond to any controller or processor or to a programmable hardware component. The control circuit 24 can also be implemented, for example, as software that is programmed for a corresponding hardware component. In this respect, the control circuit 24 can be implemented as programmable hardware having correspondingly adapted software. Any processors, such as digital signal processors (DSPs), can be used. Exemplary embodiments are not restricted to a specific type of processor. Any processors or even plurality of processors are conceivable for the implementation.

More details and aspects of the user interface controller, the corresponding method and the computer program will be mentioned in connection with the concept or examples described below (e.g. FIG. 1a to 1b, 3 to 4). The user interface controller, the corresponding method and the computer program can comprise one or more additional optional features corresponding to one or more aspects of the proposed concept or the described examples, as set out above or below.

A possible process flow is shown by way of example below, starting with the creation of a user account. When a user account of a driver is created by a vehicle manufacturer, a unique identifier can be derived (as a PCID) from a user identifier (or user account identifier) used by the user account administration, and can be assigned to this user. A provisioning certificate in accordance with ISO 15118 can then be created for this PCID. This certificate (i.e. the public part thereof) is stored at relevant external provisioning certificate collection points. The driver/user can then conclude Plug & Charge-enabled contracts for his PCID. The certificate chain or the private part of the provisioning certificate is then stored, for example, in user-specific, encrypted form. If a Plug & Charge-enabled vehicle is added to the user account, the private part of the provisioning certificate or the certificate chain can additionally be encrypted specifically for the vehicle in a container (e.g. with the vehicle identifier certificate). This container (provisioning container) is stored, for example, in a user-specific manner. When the user logs in to the vehicle (as the current vehicle user), the provisioning container can be downloaded and the contents can be stored in standard-compliant form on the vehicle (as described in connection with FIG. 1a to 1b). The contract certificates (charging contracts) required by the customer, and, in particular, the private keys thereof, can be installed in standard-compliant form. The active contract certificate can be selected as required by the customer, along with the activation status of the function per se. This information can be stored in user-specific form. The setting applies, for example, to all vehicles in which the customer is logged in. Depending on the available memory in the vehicle, all or a restricted quantity of contract certificates and provisioning certificates can be stored in the vehicle for each user or, in the event of a change of user in the vehicle, can be deleted and downloaded once more. With the login in a different vehicle of the vehicle manufacturer, the same procedure is performed as from the encryption of the provisioning container for this specific vehicle.

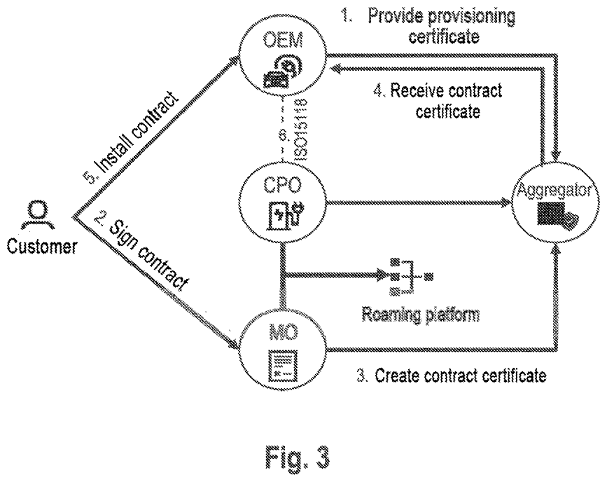

A brief overview of the mechanisms of Plug & Charge as used in the present disclosure is provided below for further understanding. Plug & Charge enables a fully automatic and secure charging experience by means of the authentication technology of EV to charging station (in accordance with ISO 15118). FIG. 3 shows a schematic diagram of Plug & Charge from a technical perspective. First (1.), the vehicle manufacturer (shown as OEM in FIG. 4) provides a provisioning certificate to an aggregator. In the present case, this provisioning certificate comprises a user-account-specific, unique identifier. The vehicle user then concludes a charging contract with the mobility operator (MO). When concluding the charging contract, the vehicle user notifies the vehicle identification number (e.g. the PCID), which can be done, for example, through the manufacturer. The mobility operator creates a contract certificate (3.) for the indicated vehicle identification number and similarly provides it to the aggregator. The aggregator informs the OEM (4.) that it has received a contract certificate and optionally forwards it to the OEM (or the contract certificate is retrieved, if required, by the OEM). The customer instructs the vehicle manufacturer, and, in particular, the vehicle, to download and install the contract certificate (5.). During the charging procedure, the vehicle manufacturer or the vehicle communicates (6.) via ISO 15118 with the charging point operator (CPO) which can then in turn make contact with the mobility operator via the aggregator and/or a roaming platform regarding the payment for the charging procedure.

FIG. 4 shows a simplified representation of the technical infrastructure for the use of Plug & Charge. FIG. 4 shows a charging controller 410, which can correspond to the charging controller 10 from FIG. 1a, a user interface controller 420, which can correspond to the user interface controller 20 from FIG. 2a and 1b, an intermediary 430 (which can be used in the vehicle or in the manufacture of the vehicle or, if a provisioning certificate is re-issued for a new user, also independently from the manufacture), a Plug & Charge coordinator 440 (on the vehicle manufacturer side), an aggregator 450, a mobility provider 460, an operator of the charging station 470, and the charging station 480. The charging controller 410 is designed for communication in accordance with ISO 15118 and is responsible for the storage and handling of the certificate (including diagnostic tasks). The intermediary is the root certificate authority of the vehicle manufacturer and provides provisioning certificates. The key pair of the provisioning certificate can be created, for example, in the charging controller 410, or on a server, such as the Plug & Charge coordinator. This is indicated by block 435 in FIG. 4.

The following steps can be carried out in order to install a new contract in the vehicle, and, in particular, in the charging controller. A provision certificate is required in order to enable the installation of charging contracts (or the corresponding certificates). In the present example, this is carried out by the intermediary 430. The intermediary 430 receives a certificate signing request (CSR), e.g. from the charging controller, and provides the charging controller 410 with a private key of the certificate, and provides the Plug & Charge coordinator 440 with a public key. This Plug & Charge coordinator 440 publishes the provision certificate (i.e. the public key thereof) in the aggregator 450. The provision certificate contains an identification code, the user-account-specific unique identifier, in cryptographically secured form. Alternatively, the intermediary can also receive the certificate signing request from a server, such as the Plug & Charge coordinator 440, e.g. when a user account is created or when the Plug & Charge functionality is enabled in the user account. Correspondingly, the key pair can be generated 435, e.g. by the charging controller 410 or a server, such as the Plug & Charge coordinator 440.

If a customer signs a charging contract, the customer indicates the identification code of the provisioning certificate (i.e. the user-account-specific, unique identifier) with respect to the mobility provider 460 as part of the contract. The mobility provider 460 creates a new contract certificate. The contract certificate can then be encrypted by means of the provision certificate (i.e. the public key), so that it can be decrypted only by a charging controller which has the private key of the provisioning certificate. The appropriate provision certificate is determined by means of the identification code (i.e. the unique identifier). The aggregator 450 receives the encrypted contract certificate and informs the Plug & Charge coordinator 440 thereof. The Plug & Charge coordinator 440 can then receive the contract certificate and provide it to the charging controller, e.g. via a telematics connection. Alternatively, the contract certificate can be exchanged between the charging station 480 and the charging controller 410 using power line communication. If the charging controller has a corresponding contract certificate, it can identify itself by means of the contract certificate via a connection which is secured by means of a TLS (Transport Layer Security) communication. The charging station identifies itself by means of a leaf certificate which is derived from a V2G (Vehicle-to-Grid) root certificate. A TLS (e.g. a TLS 1.2) connection is first set up between the charging station and the vehicle by means of the leaf certificate of the charging station (similar to transport encryption on the Internet). The contract certificate is then transmitted. The contract certificate is therefore not part of the ILS chain. In the case of TLS 1.3, a further certificate is used, which is described in ISO 15518-20. The authorization of the charging session is performed between the charging station 480, the operator of the charging station 470, and the aggregator 450, wherein the operator of the charging station 470 can determine the mobility provider 460 via the aggregator 450. The payment is then made to the mobility provider 460, under the terms of the contract, by means of an E-mobility identifier.

The user interface controller comprises a system for a graphical interface which can be based, for example, on a graphical operating system for mobile devices and can enable the on-board user guidance, as well as the configuration of the vehicle and the Plug Charge functionality, and also the actual controller functionality. The latter communicates with the charging controller 410 and receives information from the charging controller 410 relating to provisioning certificates and contract certificates stored there. A user can log in to the vehicle, for example, via the user interface controller, whereupon the corresponding provisioning certificate and contract certificate are activated. A facility for selecting one of the stored certificates can then be provided by means of the system for the graphical interface, wherein the selection is communicated to the charging controller. The user interface controller 420 further requests identifiers of new contract certificates (and V2G root certificates) from the Plug & Charge coordinator 440 in order to be able to offer the installation of the contract certificates. If the installation is instigated, the user interface controller 420 requests the respective certificates for the installation from the Plug & Charge coordinator. These certificates are then forwarded to the charging controller. A diagnostic communication, for example, and/or a status/configuration communication can be used for the communication between the user interface controller 420 and the charging controller 410.

The aspects and features which are described in connection with one specific example from the previous examples can also be combined with one or more of the further examples in order to replace an identical or similar feature of this further example or to additionally introduce the feature into the further example.

Examples can further be or relate to a (computer) program having a program code to carry out one or more of the above methods when the program is executed on a computer, a processor or other programmable hardware component. Steps, operations or processes of various of the methods described above can therefore also be carried out by programmed computers, processors or other programmable hardware components. Examples can also cover program memory devices, e.g. digital data storage media which are machine-readable, processor-readable or computer-readable and encode or contain machine-executable, processor-executable or computer-executable programs and instructions. The program memory devices can comprise or be, for example, digital memories, magnetic storage media such as, for example, magnetic disks and magnetic tapes, hard disk drives or optically readable digital data storage media. Further examples can also cover computers, processors, control units, (field-) programmable logic arrays ((F) PLAS), (field-) programmable gate arrays ((F) PGAs), graphics processor units (GPUs), application-specific integrated circuits (ASICs), integrated circuits (ICs) or systems-on-a-chip (SoCs), which are programmed to carry out the steps of the methods described above.

It is further obvious that the disclosure of a plurality of steps, processes, operations or functions is not to be interpreted as invariably requiring their performance in the described sequence, unless this is explicitly indicated in individual cases or is absolutely necessary for technical reasons. The performance of a plurality of steps or functions is not therefore restricted by the preceding description to a specific sequence. In further examples, a single step, a single function, a single process or a single operation can further include or be divided up into a plurality of partial steps, functions, processes or operations.

some aspects have been described in the preceding sections in connection with a device or a system, these aspects are also to be understood as a description of the corresponding method. A block, a device or a functional aspect of the device or of the system, for example, can correspond to a method step of the corresponding method. Aspects described in connection with a method are also to be understood accordingly as a description of a corresponding block, a corresponding element, a characteristic or a functional feature of a corresponding device or of a corresponding system.

The following claims are incorporated herewith into the detailed description, wherein each claim can stand as a separate example in itself. It should further be noted that, even if a dependent claim refers in the claims to a specific combination with one or more other claims, other examples can also comprise a combination of the dependent claim with the subject-matter of any other dependent or independent claim. Such combinations are explicitly proposed herewith, unless it is indicated in individual cases that a specific combination is not intended. Features of one claim are further intended to be included in any other independent claim, even if this claim is not directly defined as dependent on this other independent claim.

### REFERENCE SIGN LIST

5 Charging infrastructure
10 Charging controller
12 Interface
14 Cryptographically secured element
16 Control circuit
18 Memory
20 User interface controller
22 Interface
24 Control circuit
100 Vehicle
105 Memory
110 Receive a cryptographically secured provisioning certificate
120 Receive one or more cryptographically secured charging contracts
130 Store the provisioning certificate and at least one charging contract in a cryptographically secured element
140 Authenticate the charging controller
210 Receive a user input
220 Provide a control signal
410 Charging controller
420 User interface controller
430 Intermediary
435 Key generation
440 Plug & Charge coordinator
450 Aggregator
460 Mobility provider
470 Operator of a charging station
480 Charging station

1-15. (canceled)

16. A charging controller for a vehicle, the charging controller comprising:
at least one interface for communication with a charging infrastructure; a control circuit configured to:
receive a cryptographically secured provisioning certificate, wherein the cryptographically secured provisioning certificate comprises a unique identifier, wherein the unique identifier is linked to a user account of a driver of the vehicle,
receive one or more cryptographically secured charging contracts, wherein the one or more cryptographically secured charging contracts are based on the cryptographically secured provisioning certificate,
store the provisioning certificate and at least one charging contract of the one or more cryptographically secured charging contracts in a cryptographically secured element, and
authenticate the charging controller with respect to the charging infrastructure based on the at least one charging contract stored in the cryptographically secured element.

17. The charging controller as claimed in claim 16, wherein the unique identifier is not linked to the vehicle.

18. The charging controller as claimed in claim 17, wherein the control circuit is further configured to receive at least one second cryptographically secured provisioning certificate, which comprises a second unique identifier which is linked to a user account of a second driver, and one or more second cryptographically secured charging contracts based on the second provisioning certificate, to store the second provisioning certificate and at least one second charging contract of the one or more second charging contracts in the cryptographically secured element, and to authenticate the charging controller with respect to the charging infrastructure based on the at least one second charging contract.

19. The charging controller as claimed in claim 18, wherein the control circuit is configured to store the second provisioning certificate and the at least one second charging contract in addition to the provisioning certificate and the at least one charging contract in the cryptographically secured element, and to store a selection indicating which charging contract is to be used for the authentication.

20. The charging controller as claimed in claim 18, wherein the control circuit is configured to remove the provisioning certificate and the at least one charging contract in encrypted form from the cryptographically secured element, and to store the second provisioning certificate and the at least one second contract in the cryptographically secure element following the removal.

21. The charging controller as claimed in claim 20, wherein the control circuit is configured to store the provisioning certificate and the at least one charging contract in encrypted form in a further memory (18) of the charging controller, wherein the further memory is arranged outside the cryptographically secured element.

22. The charging controller as claimed in claim 20, wherein the control circuit is configured to store the provisioning certificate and the at least one charging contract in encrypted form in a further memory outside the charging controller.

23. The charging controller as claimed in claim 22, wherein the provisioning certificate and the at least one charging contract are encrypted by means of a cryptographic key which is stored within the cryptographically secured element.

24. The charging controller as claimed in claim 23, wherein the control circuit is configured to receive at least the second provisioning certificate and the one or more second charging contracts in encrypted form from a memory inside or outside the charging controller.

25. The charging controller as claimed in claim 24, wherein the control circuit is configured to perform at least reception and storage of the second provisioning certificate and the one or more second charging contracts in response to a control signal from the user interface controller of the vehicle.

26. A user interface controller for a vehicle, the user interface controller comprising:
at least one interface for communication with a charging controller of the vehicle and for communication with the user interface; and
a control circuit configured to:
receive a user input via the user interface, wherein the user input indicates that a driver of the vehicle is logging in to the vehicle via his user account; and
provide a control signal to the charging controller when a unique identifier, which is contained in a provisioning certificate on which a charging contract is based which is currently being used for authentication with respect to a charging infrastructure, is linked to a different user account, wherein the control signal indicates that a second provisioning certificate and at least one charging contract based on the second provisioning certificate are to be used for the authentication with respect to the charging infrastructure.

27. The user interface controller as claimed in claim 26, wherein the control circuit is designed to output a representation of one or more charging contracts via the user interface, said charging contracts being based on the provisioning certificate of which the unique identifier is linked to the currently logged in user account.

28. A method for a user interface controller for a vehicle, the method comprising:
receiving a user input via a user interface, wherein the user input indicates that a driver of the vehicle is logging in to the vehicle via his user account; and
providing a control signal to a charging controller of the vehicle when a unique identifier, which is contained in a provisioning certificate on which a charging contract is based which is currently being used for authentication with respect to a charging infrastructure, is linked to a different user account, wherein the control signal indicates that a second provisioning certificate and at least one charging contract based on the second provisioning certificate are to be used for authentication with respect to the charging infrastructure.

29. The method as claimed in claim 28, wherein a control circuit is designed to output a representation of one or more charging contracts via the user interface, said charging contracts being based on the provisioning certificate of which the unique identifier is linked to the currently logged in user account.

30. The method as claimed in claim 29, the method further comprising connecting a charging cable of a charging point to a charging interface of the vehicle.

31. The method as claimed in claim 30, the method further comprising, after authenticating the charging controller, charging a battery of the vehicle from the charging point via the charging cable.

32. The method as claimed in claim 30 wherein the user interface is a vehicle display.

33. A non-transitory computer-readable medium comprising instructions which, when executed by a controller, causes the controller to carry out the method as claimed in claim 28.
